(19) United States
(12) Patent Application Publication
(10) Pub. No.: US 2026/0127837 A1
(43) Pub. Date: May 7, 2026

(54) INFORMATION PROCESSING APPARATUS, CONTROL METHOD, AND NON-TRANSITORY COMPUTER READABLE MEDIUM

(71) Applicant: CANON KABUSHIKI KAISHA, Tokyo (JP)

(72) Inventor: Seiji TAKAHASHI, Kanagawa (JP)

(21) Appl. No.: 19/377,302

(22) Filed: Nov. 3, 2025

(30) Foreign Application Priority Data
Nov. 6, 2024 (JP) 2024-194711

(51) Int. Cl. G06T 19/20; G06T 7/73; G06T 7/90; G06V 10/25

(52) U.S. Cl. CPC G06T 19/20; G06T 7/73; G06T 7/90; G06V 10/25; G06T 2219/2004

(57) ABSTRACT

An information processing apparatus according to the present disclosure includes one or more processors and/or circuitry configured to execute control processing to cause a display to display an image of a virtual object so that the virtual object is arranged in a real space, and execute a detection processing to detect a hand of a user, wherein in the control processing, a display position of the virtual object is changed so that the virtual object does not overlap a hand of the user as viewed from the user.

### BACKGROUND

### Field of the Technology

The present disclosure relates to an information processing apparatus that controls a display position of a virtual object, a method of controlling the information processing apparatus, and a non-transitory computer readable medium.

### Description of the Related Art

In recent years, a so-called virtual reality (VR) technology has been known as a technology for rendering a virtual world in real time and seamlessly. In addition, a so-called mixed reality (MR) technology is known as a technology for fusing a real world and a virtual world in real time and seamlessly. As these technologies, a technology using a head mounted display (HMD) is known.

In the MR technology, it has been proposed to control a position at which a virtual object is displayed according to a condition. Japanese Patent Laid-Open No. 2019-510321 discloses moving a virtual object according to a change in a head position. Japanese Patent Laid-Open No. 2015-049039 discloses controlling a display position of a virtual object so as not to be superimposed on a real object existing around a vehicle driven by a user.

In a case where a user wearing the HMD performs work using hands while looking at the virtual object, even if the technologies disclosed in Japanese Patent Laid-Open No. 2019-510321 and Japanese Patent Laid-Open No. 2015-049039 are used, there is a possibility that the hand is hidden by the virtual object.

### SUMMARY

The present disclosure provides an information processing apparatus capable of displaying a virtual object so as not to overlap a hand of a user.

An information processing apparatus according to the present disclosure includes one or more processors and/or circuitry configured to execute control processing to cause a display to display an image of a virtual object so that the virtual object is arranged in a real space, and execute a detection processing to detect a hand of a user, wherein in the control processing, a display position of the virtual object is changed so that the virtual object does not overlap a hand of the user as viewed from the user.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of an information processing apparatus according to the present embodiment.

FIGS. 2A to 2C are diagrams illustrating an example of an image displayed on a display unit in the present embodiment.

FIG. 3 is a flowchart illustrating an operation of the information processing apparatus according to the present embodiment.

### DESCRIPTION OF THE EMBODIMENTS

In the following, an embodiment of the present disclosure is described in detail with reference to the accompanying drawings. Each of the embodiments of the present disclosure described below can be implemented solely or as a combination of a plurality of the embodiments or features thereof where necessary or where the combination of elements or features from individual embodiments in a single embodiment is beneficial.

### Configuration of information processing apparatus

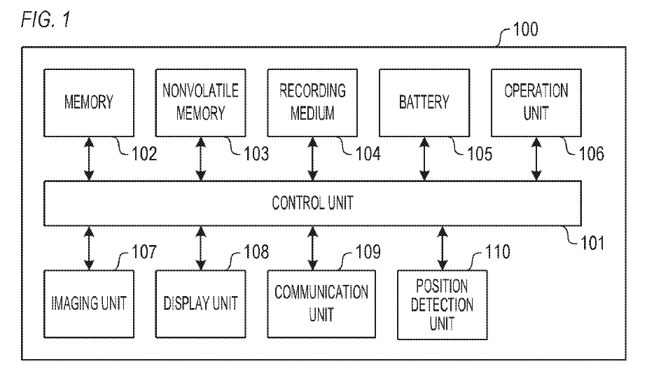

FIG. 1 is a block diagram illustrating a configuration of an information processing apparatus according to the present embodiment. In the present embodiment, an information processing apparatus 100 will be described as a video see-through HMD. The video see-through HMD presents a composite image obtained by superimposing an image of a virtual object by computer graphics (CG) on a real image captured by a camera (imaging unit) to a user wearing the HMD.

A control unit 101 controls each unit of the information processing apparatus 100 according to an input signal or a program. Note that the control unit 101 may control the entire apparatus by a plurality of pieces of hardware sharing processing instead of controlling the entire apparatus.

A memory 102 includes a random access memory (RAM) or the like. The memory 102 is used as a buffer memory that temporarily holds various data such as a rendering image and a composite image to be described later, a working memory of the control unit 101, and the like.

A nonvolatile memory 103 includes a read only memory (ROM) or the like that can be electrically stored and erased. The nonvolatile memory 103 stores programs and the like read and executed by the control unit 101.

A recording medium 104 is a memory card or the like for recording various data such as an image, and includes a semiconductor memory, a magnetic disk, or the like. The recording medium 104 may be configured to be detachable from the information processing apparatus 100 or may be built in the information processing apparatus 100. In the information processing apparatus 100, at least the control unit 101 only needs to be able to access the recording medium 104.

A battery 105 supplies power for operating the entire information processing apparatus 100. The battery 105 includes a rechargeable secondary battery, and can be charged by an external battery charger. The battery 105 may be a power receiving unit that receives power from the outside.

An operation unit 106 can receive various operations from the user. For example, the operation unit 106 includes various operation members such as a power button and an operation button. By using the operation unit 106, the user can give an instruction to turn on/off the power of the information processing apparatus 100, switch the operation mode, change the setting, and the like, for example.

An imaging unit 107 is a camera or the like that converts light into an electrical video signal. The imaging unit 107 includes, for example, an optical system such as an optical lens unit, an imaging element for converting light introduced through the optical lens unit into an electrical video signal, and the like. The imaging unit 107 captures an image of a real space (real image) by capturing an image in front of the user. The imaging unit 107 may be, for example, a binocular camera (dual-lens camera, stereo camera) including a camera provided to correspond to the left eye of the user and a camera provided to correspond to the right eye of the user. The imaging unit 107 may be able to acquire an image (stereo image) having two image areas with parallax for the right eye and the left eye. In the information processing apparatus 100, the real image captured by the imaging unit 107 is used as a background image of the composite image.

A display unit 108 is a display element including an organic EL display, a liquid crystal display, or the like. The display unit 108 includes two display elements respectively corresponding to the right eye and the left eye of the user. The control unit 101 generates two images respectively corresponding to the right eye and the left eye of the user as a composite image in which an image of a virtual object by computer graphics (CG) is superimposed on the real image captured by the imaging unit 107. The control unit 101 causes the display unit 108 to display the composite image so as to show the user that the virtual object is arranged in the real space.

The communication unit 109 includes, for example, an antenna for wireless communication, a modulation/demodulation circuit for processing a wireless signal, and a communication controller. The communication unit 109 outputs the modulated wireless signal from the antenna and demodulates the wireless signal received by the antenna. The control unit 101 may perform wireless communication according to the IEEE802.11 standard by controlling the communication unit 109. The control unit 101 controls the communication unit 109 to communicate with an external device. The communication with the external device may or may not be communication via the Internet.

A position detection unit 110 is a sensor for acquiring information regarding the position and orientation of the information processing apparatus 100. The position detection unit 110 may be an inertial measurement unit (IMU) including an acceleration sensor, a gyro sensor, a geomagnetic sensor, and the like. The control unit 101 estimates the movement (position and orientation) of the head of the user by specifying the position and orientation of the information processing apparatus 100 from the sensor value of the position detection unit 110.

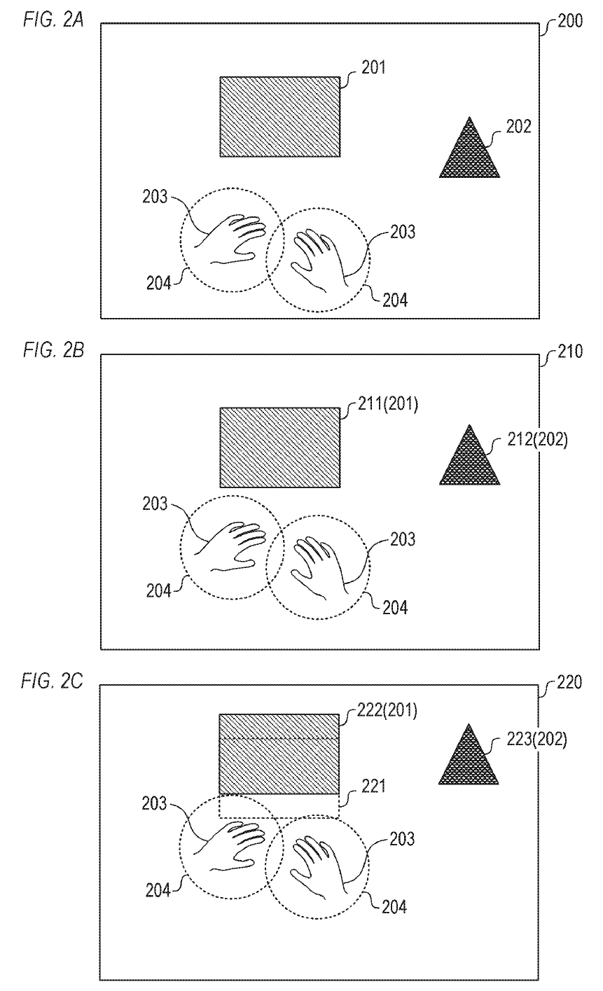

FIGS. 2A to 2C are diagrams illustrating an example of an image output to the display unit 108 by the control unit 101 in the present embodiment and displayed on the display unit 108. Note that FIGS. 2A to 2C illustrate only one of the two composite images for the right eye and the left eye output by the control unit 101. In FIGS. 2A to 2C, the control unit 101 outputs only the image indicated by the solid line to the display unit 108, and does not output the image indicated by the dotted line to the display unit 108.

A display image 200 illustrated in FIG. 2A is an example of a composite image displayed on the display unit 108 in a case where the user of the information processing apparatus 100 performs work using a hand while viewing a virtual object.

A following virtual object 201 is a virtual object displayed so as to follow the movement of the head of the user. The following virtual object 201 includes, for example, a moving image, a still image, a 3DCG model, and the like. The following virtual object 201 may be, for example, a virtual object for supporting work using a hand of the user, such as an instruction or a video for describing the work.

A fixed virtual object 202 is a virtual object displayed on the display unit 108 so as to be fixed at a predetermined position in the real space.

A hand 203 is a hand of the user included in the real image captured by the imaging unit 107. The control unit 101 detects the hand 203 (a position or an area of hand 203) from the real image. The control unit 101 may detect the area of the hand 203 by performing at least one of processing of detecting the color of the skin (hand) of the user from the real image, processing of detecting joint points from the real image, and processing of detecting a rectangular area corresponding to the area of the hand 203 from the real image. The distance to the depth of the hand may be obtained together with the area of the hand. For example, the distance from the imaging unit to coordinates representing the hand may be calculated using triangulation or the like.

The control unit 101 may detect the area of the hand 203 by a machine learning model, or may detect the area of the hand 203 by pattern matching using a hand pattern stored in advance in the recording medium 104. Furthermore, the control unit 101 may detect the area of the hand by combining two or more of a plurality of pieces of processing including processing of detecting the skin color from the real image, processing of detecting the articulation points from the real image, and processing of detecting the rectangular area corresponding to the area of the hand 203 from the real image.

An area 204 of the hand 203 is an area (a peripheral area of the hand 203) from the position of the hand 203 to a position away from the position of the hand by a predetermined distance in the real image. For example, the control unit 101 detects the position of the hand 203 by performing at least one of processing of detecting the color of the skin (hand) of the user from the real image, processing of detecting joint points from the real image, and processing of detecting a rectangular area corresponding to the area of the hand 203 from the real image. Then, the control unit 101 determines (calculates) an area from the position of the hand 203 to a position separated by a predetermined distance as the area 204 of the hand 203. However, the area 204 of the hand 203 is not limited thereto, and may be, for example, the area of the hand 203 itself obtained by detecting the contour of the hand 203.

A display image 210 illustrated in FIG. 2B is an example of a composite image displayed on the display unit 108 when the user faces downward from the state of FIG. 2A.

The following virtual object 201 is displayed in an area 211 similar to the area of the following virtual object 201 in FIG. 2A so as to follow the movement of the head of the user. The fixed virtual object 202 is displayed in the area 211 reflecting the movement of the head of the user so as to be fixed at a predetermined position in the real space. The area 211 is an area obtained by moving the area of the fixed virtual object 202 in FIG. 2A upward.

A display image 220 illustrated in FIG. 2C is an example of a composite image displayed on the display unit 108 when the user faces downward from the state of FIG. 2B.

A following area 221 indicates an area in which the following virtual object 201 moves when the following virtual object 201 is moved in accordance with the movement of the head of the user in the real space. In FIG. 2C, the following virtual object 201 moves so as to overlap the area 204 of the hand 203, and the following area 221 overlaps the area 204 of the hand 203. When the following area 221 overlaps with the area 204 of the hand 203, the following virtual object 201 is displayed in a proximity area 222 so as to stop at a position close to the hand 203 (a position away from the position of the hand 203 by a predetermined distance). In this manner, the control unit 101 changes the display position of the following virtual object 201 so that the following virtual object 201 does not overlap the hand 203 as viewed from the user. Here, the position of the following virtual object 201 close to the hand 203 is, for example, a position where the area of the following virtual object 201 is in contact with the area 204 of the hand 203.

The fixed virtual object 202 is displayed in an area 223 reflecting the movement of the head of the user so as to be fixed at a predetermined position in the real space. The area 223 is an area obtained by moving the area 211 of the fixed virtual object 202 in FIG. 2B upward.

As described above, the control unit 101 of the present embodiment changes the display position of the following virtual object 201 so that the following virtual object 201 follows the movement of the head of the user and the virtual object is not superimposed and displayed in the area 204 of the hand 203. As a result, the virtual object does not overlap the hand of the user, and thus, for example, the user can perform work while displaying the virtual object for work support and checking the hand. That is, the work can be performed while the virtual object and the user's hand are in the same field of view.

### Operation of information processing apparatus

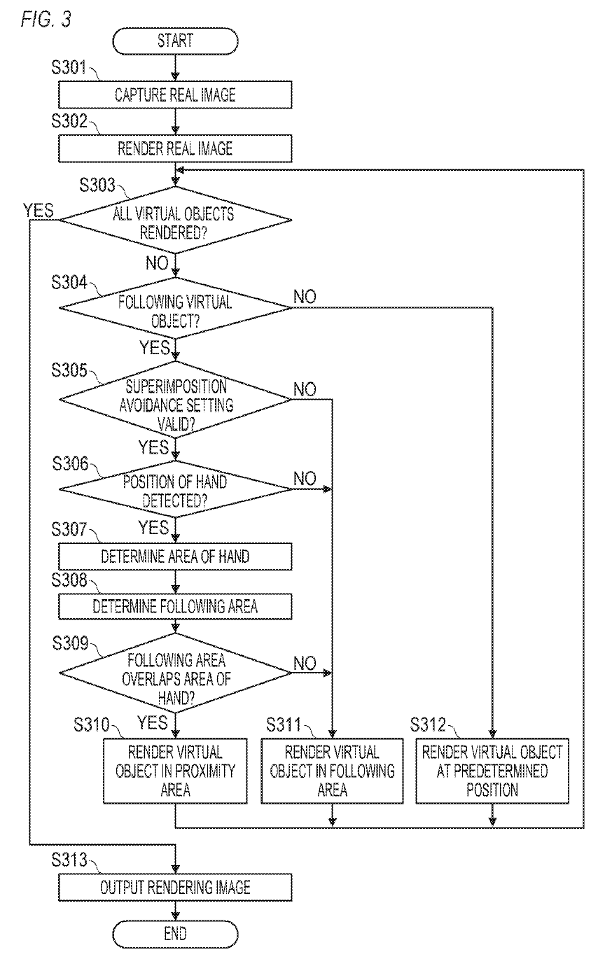

The operation of the information processing apparatus 100 will be described with reference to FIG. 3. FIG. 3 is a flowchart illustrating an operation in which the information processing apparatus 100 according to the present embodiment outputs a composite image to the display unit 108. The processing illustrated in FIG. 3 is implemented by the control unit 101 reading a program or the like stored in the nonvolatile memory 103, processing an input signal input from each unit of the information processing apparatus 100, and controlling each unit of the information processing apparatus 100. The control unit 101 repeats the processing illustrated in FIG. 3 in accordance with a predetermined cycle.

In S301, the control unit 101 controls the imaging unit 107 to image the real space and acquire the real image.

In S302, the control unit 101 renders the real image acquired in S301 into a format that can be output to the display unit 108, and stores the real image in the memory 102 as a rendering image.

In S303, the control unit 101 determines whether or not all the virtual objects have been rendered. In a case where the control unit 101 determines that all the virtual objects have been rendered, the processing proceeds to S313, and otherwise, the processing proceeds to S304.

In S304, the control unit 101 determines whether or not the virtual object to be rendered is a following virtual object. The control unit 101 refers to the memory 102 to determine whether the virtual object to be rendered is a following virtual object or a fixed virtual object. Whether or not the virtual object is a following virtual object may be set in advance depending on the type of the virtual object, or may be set by the user for each virtual object. In a case where the control unit 101 determines that the virtual object to be rendered is a following virtual object, the processing proceeds to S305, and otherwise, the processing proceeds to S312.

In S305, the control unit 101 refers to the memory 102 and determines whether or not the setting (superimposition avoidance setting) for displaying the virtual object so as not to overlap the area of the hand is valid. The user may be able to select a mode from a plurality of modes including a mode in which the virtual object is allowed to overlap the user's hand and a mode in which the display position of the virtual object is changed so that the virtual object does not overlap the user's hand. The user may be able to select a mode by a menu operation or the like using the operation unit 106. In a case where the control unit 101 determines that the superimposition avoidance setting is valid, the processing proceeds to S306, and otherwise, the processing proceeds to S311.

In S306, the control unit 101 performs hand detection processing of detecting the position of the hand of the user from the real image captured by the imaging unit 107. The control unit 101 advances the processing to S307 in a case where the position of the hand can be detected by the hand detection processing, and advances the processing to S311 otherwise.

In S307, the control unit 101 determines (calculates) an area of the hand of the user at the position of the hand of the user detected in S306. The control unit 101 determines an area from the position of the hand detected in S306 to a position separated by a predetermined distance as a hand area. The area of the hand determined in S307 corresponds to the area 204 illustrated in FIGS. 2A to 2C.

In S308, the control unit 101 determines (calculates) a following area, which is an area where a virtual object to be rendered is arranged when the virtual object follows the movement of the head of the user. The following area determined in S308 corresponds to the following area 221 illustrated in FIG. 2C.

In step S309, the control unit 101 determines whether or not the following area determined in step S308 overlaps with the area of the hand determined in step S307. In a case where the control unit 101 determines that the following area overlaps with the hand area, the processing proceeds to S310, and otherwise, the processing proceeds to S311.

In S310, the control unit 101 renders the virtual object so as to stop at a position close to the area of the hand determined in S307 (in the proximity area). The control unit 101 superimposes and renders a virtual object on the rendering image stored in the memory 102, and stores the composite image in the memory 102. The virtual object rendered by the control unit 101 in S310 corresponds to the following virtual object 201 arranged in the proximity area 222 illustrated in FIG. 2C.

In S311, the control unit 101 renders the virtual object in the following area determined in S308. The control unit 101 superimposes and renders a virtual object on the rendering image stored in the memory 102, and stores the composite image in the memory 102. The virtual object rendered by the control unit 101 in S311 corresponds to the following virtual object 201 illustrated in FIGS. 2A and 2B.

In S312, the control unit 101 renders the virtual object so as to be fixed at a predetermined position in the real space. The control unit 101 superimposes and renders a virtual object on the rendering image stored in the memory 102, and stores the composite image in the memory 102. The virtual object rendered by the control unit 101 in S312 corresponds to the fixed virtual object 202 illustrated in FIGS. 2A to 2C.

In S313, the control unit 101 outputs the composite image stored in the memory 102 to the display unit 108 to display the composite image on the display unit 108.

As described above, the control unit 101 according to the present embodiment controls the following virtual object to follow the movement of the head of the user and not to display the following virtual object in an overlapping manner in the area of the hand. As a result, the user can work with his/her hands in the same field of view as those of the following virtual object serving as work support.

### Modified Example

In the present embodiment, the hand of the user is detected from the real image displayed as the background image, but the method of detecting the hand is not limited thereto. For example, the information processing apparatus 100 may include a dedicated imaging unit, a sensor (for example, an infrared sensor), or the like for detecting a hand. The dedicated imaging unit, sensor, or the like for detecting the hand of the user may be an external device connected to the information processing apparatus 100 in a wired or wireless manner. Furthermore, in a case where a wearable device capable of acquiring a position is worn on the hand of the user, the hand of the user may be detected with further reference to the position of the wearable device. For example, in a case where a plurality of hands are shown in the real image, if the user wears a wearable device, the hand of the user can be detected among the plurality of hands in the real image.

In the present embodiment, the area of the hand is detected, and the following virtual object is controlled not to be superimposed and displayed in the area of the hand. However, the following virtual object satisfying a specific condition may be controlled to be displayed to be superimposed on the area of the hand, and such a specific condition may be selected in detail by the user from the above-described superimposition avoidance setting (step S305). For example, by acquiring the depth information of the hand, the following virtual object at the depth of the hand may be set to be displayed to be superimposed on the area of the hand. In this case, in the following virtual object, a portion overlapping the hand is not displayed in order to express that the portion is at the depth of the hand. For example, when a virtual object is superimposed on a real image, a portion overlapping a hand of the virtual object is excluded. In this way, it is expressed that a part of the following virtual object is hidden due to the presence of the hand when viewed by the user, and the depth relationship in the virtual space (mixed reality space) can be expressed.

Furthermore, as a specific condition of the superimposition avoidance setting, setting based on work content may be possible. For example, in a case where the GUI provided in the following virtual object is operated, in a case where it is determined that the work content of the user is not dangerous, or in a case where the content to be displayed in the following virtual object is important, the following virtual object may be controlled to be displayed to be superimposed on the area of the hand. Note that, in a case where the virtual object is displayed to be superimposed on the area of the hand in this manner, the following virtual object may be displayed so that the hand is hidden, and as described above, a portion overlapping the hand of the virtual object may be excluded. On the contrary, in a case where the work content of the user is determined to be dangerous, for example, in a case where a knife is used, the following virtual object may be controlled not to be superimposed and displayed in the area of the hand. Alternatively, in a case where the content displayed on the following virtual object is a rewindable moving image or the like and is not important, the following virtual object may be controlled not to be superimposed and displayed on the area of the hand.

In the present embodiment, the information processing apparatus 100 is a video see-through HMD, but the information processing apparatus 100 is not limited thereto. For example, the information processing apparatus 100 may be an optical see-through HMD (for example, AR glasses). The optical see-through HMD displays an image of a virtual object without displaying a real image. Therefore, in a case where a dedicated imaging unit or sensor for detecting the hand of the user is used, the information processing apparatus 100 may not include the imaging unit 107. The information processing apparatus 100 may be a computer or the like that is connected to the HMD and controls the HMD to display an image.

In the present embodiment, the composite image in which the following virtual object and the fixed virtual object are superimposed on the real image is generated, but the composite image is not limited thereto. For example, in a case where the following area 221 overlaps the area 204 of the hand 203, the control unit 101 may generate a composite image indicating the area 204 in an identifiable manner. As a result, the user can grasp that the following virtual object 201 is controlled so as not to hide his/her hand. Note that the method for making the area 204 of the hand 203 identifiable is not particularly limited as long as the method does not hinder the visual recognition of the hand 203, and for example, the area 204 may be made identifiable with a translucent mask or a frame. Furthermore, the control unit 101 may notify the user that the hand is controlled not to be hidden by the following virtual object 201 by a method different from the method of making the area 204 of the hand 203 identifiable. For example, the user may be notified by displaying an icon indicating that the superimposition avoidance setting is valid.

In the present embodiment, the fixed virtual object is fixed at a predetermined position in the real space, and the fixed virtual object is allowed to overlap the hand of the user. However, as with the following virtual object, the display position of the fixed virtual object may be changed so as not to overlap the hand of the user. For example, in a case where the fixed virtual object is to be displayed as if it existed in the real space, the fixed virtual object may be displayed so as to be fixed at a predetermined position in the real space while allowing the fixed virtual object to overlap the hand of the user.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, a virtual object can be displayed so as not to overlap a hand of a user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-194711, filed November 6, 2024, which is hereby incorporated by reference herein in its entirety.

What is claimed is:

1. An information processing apparatus comprising:
one or more processors and/or circuitry configured to
execute control processing to cause a display to display an image of a virtual object so that the virtual object is arranged in a real space, and
execute a detection processing to detect a hand of a user, wherein
in the control processing, a display position of the virtual object is changed so that the virtual object does not overlap a hand of the user as viewed from the user.

2. The information processing apparatus according to claim 1, wherein in the detection processing, at least one of processing of detecting a predetermined color from an image obtained by imaging a real space, processing of detecting joint points from the image, and processing of detecting a rectangular area corresponding to the area of the hand from the image is performed to detect the area of the hand.

3. The information processing apparatus according to claim 1, wherein in the detection processing, an area from a position of the hand to a position away from the position of the hand by a predetermined distance is detected as an area of the hand.

4. The information processing apparatus according to claim 1, wherein in the control processing, a display position of the virtual object is changed so that the virtual object stops at a position close to the hand in a case where the virtual object moves so that the virtual object would otherwise overlap the hand.

5. The information processing apparatus according to claim 1, wherein in the control processing, the display position of the virtual object is changed so that the virtual object does not overlap the hand of the user only in a case where the virtual object is a virtual object that follows movement of the head of the user.

6. The information processing apparatus according to claim 1, wherein the one or more processors and/or circuitry further execute setting processing to set any one of a plurality of modes including a first mode in which the virtual object is allowed to overlap the hand of the user and a second mode in which a display position of the virtual object is changed such that the virtual object does not overlap the hand of the user.

7. A control method of an information processing apparatus, comprising:
causing a display to display an image of a virtual object so that the virtual object is arranged in a real space; and
detecting a hand of a user, wherein
a display position of the virtual object is changed so that the virtual object does not overlap a hand of the user as viewed from the user.

8. A non-transitory computer readable medium that stores a program, wherein the program causes a computer to execute a control method of an information processing apparatus, comprising:
causing a display to display an image of a virtual object so that the virtual object is arranged in a real space; and
detecting a hand of a user, wherein
a display position of the virtual object is changed so that the virtual object does not overlap a hand of the user as viewed from the user.
